(19) United States
(12) Patent Application Publication
(10) Pub. No.: US 2026/0126325 A1
(43) Pub. Date: May 7, 2026

(54) METHOD FOR CALCULATING PHASE AND PHASE CALCULATING APPARATUS

(71) Applicant: Mitsubishi Electric Corporation, Tokyo (JP)

(72) Inventor: Takahiro SAKAI, Tokyo (JP)

(73) Assignee: Mitsubishi Electric Corporation, Tokyo (JP)

(21) Appl. No.: 19/272,862

(22) Filed: Jul. 17, 2025

(30) Foreign Application Priority Data
Nov. 1, 2024 (JP) 2024-192598

(51) Int. Cl. G01J 9/00

(52) U.S. Cl. CPC G01J 9/00

(57) ABSTRACT

A method for calculating a phase includes irradiating a plurality of lights with different wavelengths on an optical component via a measurement target, obtaining intensity of the plurality of lights by a detector while fixing a position of the detector, the plurality of lights propagating along mutually different paths by transmitting through the optical component, and calculating a phase from the intensity of the plurality of lights.

### BACKGROUND

### Field

The present disclosure relates to a method for calculating a phase and a phase calculating apparatus.

### Background

JP 2019-200080 A discloses a method for calculating a phase of a propagated light. In this method, the intensity of the propagation light is obtained in multiple types by changing the propagation distance, and a transport of intensity equation is calculated from the information of the multiple types of intensity and the propagation distance.

In the method of JP 2019-200080 A, in order to obtain multiple propagation light intensity by changing the propagation distance, it is necessary to shift a detector in the direction of light travel. Therefore, there may be a need for high-precision alignment in the optical axis direction. Further, the imaging speed may be rate-limiting to the operation of the device.

### SUMMARY

The present disclosure has been made to solve the above-mentioned problems, and aims to obtain a method for calculating a phase and a phase calculating apparatus capable of fixing the position of a detector.

The features and advantages of the present disclosure may be summarized as follows.

According to an aspect of the present disclosure, a method for calculating a phase includes irradiating a plurality of lights with different wavelengths on an optical component via a measurement target, obtaining intensity of the plurality of lights by a detector while fixing a position of the detector, the plurality of lights propagating along mutually different paths by transmitting through the optical component, and calculating a phase from the intensity of the plurality of lights.

According to an aspect of the present disclosure, a phase calculating apparatus includes an optical component configured to allow incidence of a plurality of lights with different wavelengths that have passed through a measurement target, a detector configured to detect intensity of the plurality of lights propagating along mutually different paths by transmitting through the optical component, and a calculation circuit configured to calculate a phase from the intensity of the plurality of lights.

Other and further objects, features and advantages of the disclosure will appear more fully from the following description.

### BRIEF DESCRIPTION OF DRAWINGS

FIG. 1 is a diagram illustrating the method for calculating the phase using the transport of intensity equation.

FIG. 2 is a diagram showing an example of light intensity distribution and phase distribution.

FIG. 3 is a diagram illustrating the configuration of the phase calculation apparatus according to Embodiment 1.

FIG. 4 is a diagram illustrating the propagation of the plurality of lights according to Embodiment 1.

FIG. 5 is a flowchart showing the method for calculating the phase according to Embodiment 1.

FIG. 6 is a hardware configuration diagram of the calculation circuit according to Embodiment 1.

FIG. 7 is a diagram illustrating the configuration of the phase calculation apparatus according to Embodiment 2.

FIG. 8 is a diagram illustrating the propagation of the plurality of lights according to Embodiment 2.

FIG. 9 is a flowchart showing the method for calculating the phase according to Embodiment 2.

FIG. 10 is a diagram explaining the configuration of the phase calculation apparatus according to Embodiment 3.

FIG. 11 is a diagram illustrating the propagation of the plurality of lights according to Embodiment 3.

FIG. 12 is a perspective view of the color filter according to Embodiment 3.

FIG. 13 is a diagram illustrating the configuration of the phase calculating apparatus according to Embodiment 4.

FIG. 14 is a diagram illustrating the first-order diffracted light component and the negative first-order diffracted light component detected by the detector according to Embodiment 4.

### DESCRIPTION OF EMBODIMENTS

The method for calculating a phase and phase calculating apparatus according to each embodiment will be described with reference to the drawings. The same or corresponding components are given the same reference numerals, and repeated descriptions may be omitted.

### Embodiment 1

First, the Transport of Intensity Equation (TIE) will be described. The TIE is represented by the following Equation (1).

$$\begin{matrix}[ Equation 1 ] & \\ {{∇}_{⊥}}^{2} {ϕ}_{z} ( x , y ) = - \frac{k}{{I}_{0}} \frac{\partial {I}_{z} ( x , y )}{\partial z} & ( 1 )\end{matrix}$$

φ_{z}(x,y) is the phase distribution, and V, is the two-dimensional gradient operator. k is the wave number, and I₀ is the intensity of the in-focus image. I_{z}(x,y) is the intensity distribution. In other words, the partial differential on the right side of Equation (1) represents the intensity change in the optical axis direction. Equation (2) represents the phase solution of the TIE.

$$\begin{matrix}[ Equation 2 ] & \\ {ϕ}_{z} ( x , y ) = IFT [ \frac{1}{4 {π}^{2} ( {μ}^{2} + {v}^{2} )} FT [ \frac{k}{{I}_{0}} \frac{\partial {I}_{z} ( x , y )}{\partial z} ] ] & ( 2 )\end{matrix}$$

FT[ . . . ] is the Fourier transform operator, and IFT[ . . . ] is the inverse Fourier transform operator. μ and v are the spatial frequencies in the x and y directions, respectively. Equation (3) is derived from the difference approximation of Equation (2).

$$\begin{matrix}[ Equation 3 ] & \\ \frac{\partial {I}_{z} ( x , y )}{\partial z} \approx \frac{{I}_{Δ z} ( x , y ) - {I}_{- Δ z} ( x , y )}{2 Δ z} & ( 3 )\end{matrix}$$

Δz is the defocus distance. Hereinafter, the position that acquires intensity in the optical axis direction may be referred to as the defocus distance.

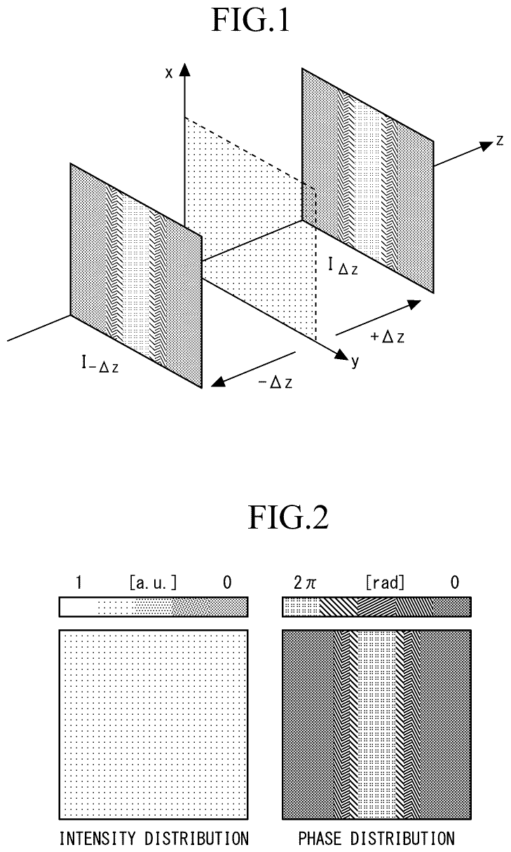

FIG. 1 is a diagram explaining a method for calculating a phase using the transport-of-intensity equation. FIG. 2 is a diagram showing an example of the intensity distribution and the phase distribution of light. FIG. 2 shows an example of the intensity distribution and the phase distribution of light at the position z=0. According to Equations (2) and (3), it is possible to calculate the phase φ_{z} by acquiring the intensity I_{Δz} and I_{-Δz} of light propagated from z=0 to ±Δz and performing a difference approximation. In this case, a phase distribution can be calculated if there are at least two intensity distributions with different defocus distances. Furthermore, the more intensity distributions with different defocus distances there are, the better the precision of the phase. This is called higher-order TIE.

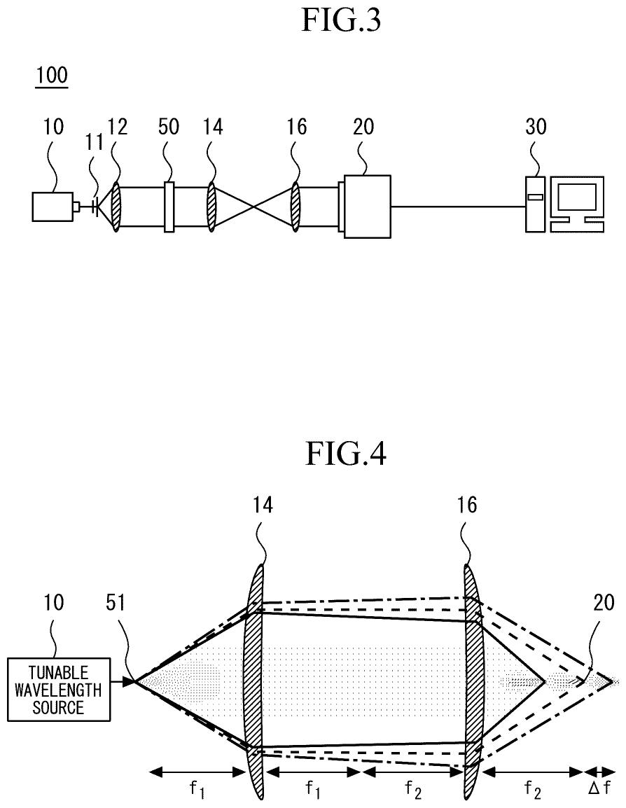

FIG. 3 is a diagram illustrating the configuration of a phase calculation apparatus 100 according to Embodiment 1. A light source 10 is a tunable wavelength source. The light source 10 emits a plurality of lights of different wavelengths in sequence. The light source 10 is, for example, a TLD (Tunable Laser Diode). The light emitted from the light source 10 becomes collimated light by means of a spatial filter 11 and a lens 12. The spatial filter 11 and the lens 12 are collectively referred to as a collimator. The light that has passed through the lens 12 passes through an object 50 which is the measurement target. Light transmitted through the object 50 passes through lenses 14 and 16, which are optical components, and its intensity is obtained by a detector 20. The detector 20 is, for example, a monochrome camera. A calculation circuit 30 is configured to calculate a phase from the intensity of the plurality of lights obtained by the detector 20.

FIG. 4 is a diagram explaining the propagation of the plurality of lights according to Embodiment 1. In FIG. 4, an example of paths for the plurality of lights with different wavelengths propagated from an object surface 51 of the object 50 is shown. A solid line represents an example path for blue light, a broken line for green light, and a chain double-dashed line for red light. Also, f1 and f2 denote the focal lengths of lenses 14 and 16, respectively. It should be noted that in FIG. 4, the collimator is omitted. Further, FIG. 4 conveniently illustrates how an image is formed when the object 50 is a simple point light source. The lenses 14 and 16 transmit and refract light. Here, the refractive index of the lenses 14 and 16 varies depending on the wavelength of the light. Therefore, as shown in FIG. 4, the plurality of lights of different wavelengths are dispersed upon transmission through the lenses 14 and 16, resulting in chromatic aberration. In FIG. 4, an example of chromatic aberration is shown as Δf.

In the embodiment, by utilizing this chromatic aberration, a plurality of images with different defocus distances are captured while keeping the position of the detector 20 fixed. That is, the intensity of the plurality of lights, which are dispersed and have different optical paths, are measured with the detector 20 fixed. By this means, capturing images equivalent to imaging at two or more locations on the z-axis becomes possible. From the above, the phase can be calculated using Equations (2) and (3).

In the phase calculating apparatus 100 of the present embodiment, lenses 14 and 16 are configured to allow the plurality of lights of different wavelengths, transmitted through the object 50, to be incident. Additionally, the detector 20 is configured to detect the intensity of the plurality of lights that propagate along different paths by passing through the lenses 14 and 16. When detecting the intensity of the plurality of lights, the position of the detector 20 is fixed.

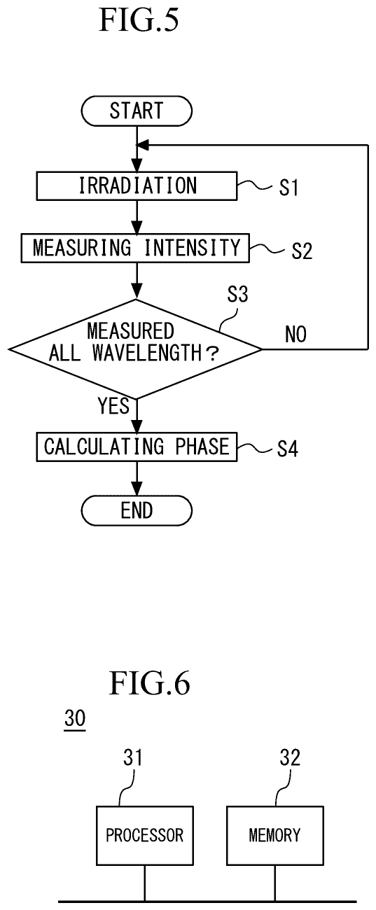

FIG. 5 is a flowchart showing a method for calculating the phase according to Embodiment 1. First, light of a first wavelength among the plurality of lights having different wavelengths is irradiated through the object 50 onto the lenses 14 and 16 (Step 1). Next, with the position of the detector 20 fixed, the intensity of the light of the first wavelength is acquired by the detector 20 (Step 2). Steps 1 and 2 are repeated for all wavelengths of the lights (Step 3).

In other words, after completing measurement at the first wavelength, among the plurality of lights, light of the second wavelength is irradiated to lenses 14 and 16 through the object 50 (Step 1). At this time, the light of the first wavelength and the light of the second wavelength traverse different paths by being transmitted through the lenses 14 and 16. Next, the intensity of the light at the second wavelength is acquired by detector 20 without moving its position from the previous measurement (Step 2).

In this manner, the plurality of lights are sequentially irradiated on lenses 14 and 16, and the intensity of the plurality of lights with different focusing positions are obtained. Next, the phase is calculated from the intensity of the plurality of lights (Step 4).

From the above, for the method for calculating the phase and the phase calculation apparatus 100 according to the present embodiment, the phase is calculated from the intensity of the plurality of lights that propagate through different paths by passing through optical components. Therefore, the position of the detector 20 can be fixed. In other words, it becomes unnecessary to move the position of the detector 20 mechanically. For this reason, the precision of alignment in the optical axis direction can be relaxed. Moreover, errors due to manual adjustment of the defocus distance can be eliminated. Furthermore, the imaging speed can be prevented from being limited by the operation of the equipment.

According to the phase distribution obtained by the above methods, for example, the refractive index or thickness of the object 50, which is a measurement target, can be calculated. Moreover, visualization of the colorless and transparent object 50 becomes possible. This information is used as an important parameter during measurement and inspection, and is mainly expected to be applied in the following two fields.

The first one is the inspection of optical components such as lenses and prisms. In general, when inspecting for defects in optical components, it is necessary to use special components such as a light source outside the visible light region, like an X-ray, and a detector with a corresponding wavelength sensitivity band. For this reason, there was a concern that the inspection device might become costly. In contrast, in the present embodiment, inspection in the visible light region is possible. Accordingly, it becomes possible to use general-purpose components for the visible light region, allowing for the realization of a low-cost inspection device. Furthermore, the present embodiment may be applied to methods of manufacturing, such as a microscope.

The second aspect is quantitative observation of colorless and transparent biological cells. In methods using high-energy X-rays, there is a risk of damaging and killing the biological cells. Therefore, it is common to stain the cells and observe them in the visible light region. However, this method results in only qualitative observation and cannot quantitatively evaluate the characteristics of biological cells. In the field of regenerative medicine, such as iPS cells, cells are transplanted into the human body after being observed. For this reason, staining of the cells is undesirable. In response to these issues, the present embodiment can calculate quantitative values within the low-energy visible light region. Furthermore, biological cells can be observed without staining.

FIG. 6 is a hardware configuration diagram of the calculation circuit 30 according to Embodiment 1. The function of the calculation circuit 30 is realized by one or more control circuits such as a processor 31. The control circuit may be a dedicated hardware. Additionally, the control circuit may be a CPU (Central Processing Unit) that executes a program stored in the memory 32. The CPU can be a central processing unit, a processing unit, a computing unit, a microprocessor, a microcomputer, a processor, or a DSP (Digital Signal Processor).

If a control circuit is dedicated hardware, the control circuit may be, for example, a single circuit, a composite circuit, a programmed processor, or a parallel programmed processor. Additionally, the control circuit may be an ASIC (Application Specific Integrated Circuit) or an FPGA (Field-Programmable Gate Array). Furthermore, the control circuit may also be a combination of these. In addition, each function of the calculation circuit 30 may be realized by a separate control circuit. Alternatively, the functions of each part may be collectively realized by a single control circuit.

When the control device is a CPU, the function of the calculation circuit 30 is realized by software, firmware, or a combination of software and firmware. The software and firmware are described as a program and stored in one or more memories 32. The control circuit realizes the functions of each part by reading and executing the program stored in memory 32.

That is, the memory 32 stores a program for calculating the phase from the intensity of a plurality of lights. These programs cause the computer to execute procedures or methods in the calculation circuit 30.

Here, the memory 32 may be a non-volatile or volatile semiconductor memory such as a RAM, a ROM, a flash memory, an EPROM, or an EEPROM, a magnetic disk, a flexible disk, an optical disk, a compact disk, a mini disk, a DVD, or the like. RAM is an abbreviation for Random Access Memory. ROM is an abbreviation for Read Only Memory. EPROM is an abbreviation for Erasable Programmable Read Only Memory. EEPROM stands for Electrically Erasable Programmable Read-Only Memory.

In addition, regarding each function of the calculation circuit 30, it is also acceptable to realize part of it using dedicated hardware and another part using software or firmware. In this manner, the control circuit can be realized through hardware, software, firmware, or a combination of these to achieve each of the aforementioned functions.

The arrangement and type of each element in the phase calculating apparatus 100 can be altered in any way, as long as the intensity of a plurality of lights propagating through different paths by passing through the optical components can be acquired, with the position of the detector 20 fixed.

The deformation described above can be appropriately applied to the method for calculating the phase and the phase calculation apparatus according to the following embodiments. In terms of the phase calculation method and phase calculation apparatus concerning the following embodiments, since there are many commonalities with Embodiment 1, the explanation will focus on the differences from Embodiment 1.

### Embodiment 2

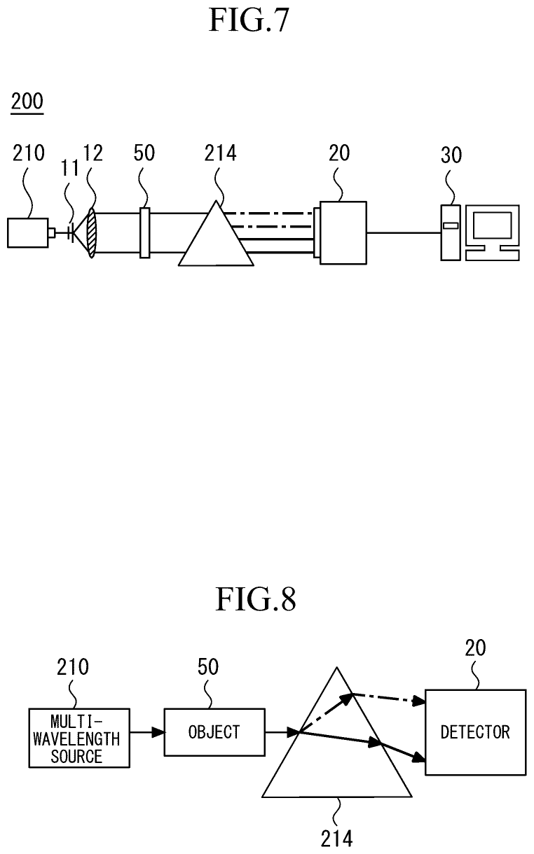

FIG. 7 is a diagram illustrating the configuration of a phase calculation apparatus 200 according to Embodiment 2. In the phase calculating apparatus 200, a prism 214 is provided as the optical component instead of lenses 14 and 16. Also, the light source 210 is a multi-wavelength source. The light source 210 simultaneously irradiates the prism 214 with the plurality of lights of different wavelengths. The light source 210 is, for example, a M/W (Multi Wavelength) LD. Other configurations are similar to those of Embodiment 1.

FIG. 8 is a diagram for explaining the propagation of a plurality of lights according to Embodiment 2. In FIG. 8, collimator is omitted. In addition, in FIG. 8, for convenience, how images are focused when the object 50 is a simple point source is shown. In the present embodiment, a plurality of lights with different wavelengths are dispersed by a dispersion element such as the prism 214. In FIG. 8, a solid line demonstrates an example of a path of blue light, and a one-dot chain line demonstrates an example of a path of red light.

In this embodiment, dispersion by the prism 214 is utilized to image multiple images with different defocus distances in a single shot, while keeping the position of the detector 20 fixed. In other words, That is, the intensity of the plurality of lights that are dispersed and have different optical paths are simultaneously acquired by fixing the position of the detector 20. As a result, imaging equivalent to that at two or more locations on the z axis can be performed. Therefore, the phase can be calculated using equations (2) and (3).

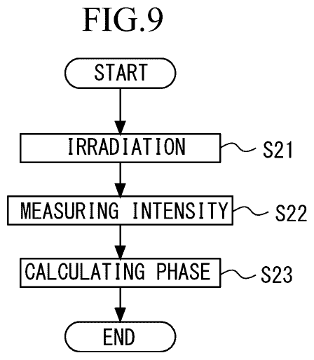

FIG. 9 is a flowchart showing the method for calculating the phase according to Embodiment 2. First, a plurality of lights having different wavelengths are simultaneously irradiated onto a prism 214 through an object 50 to be measured (Step 21). This disperses the plurality of lights. Next, while keeping the position of the detector 20 fixed, the intensity of the plurality of lights that propagate along different paths after dispersing is measured by the detector 20 (Step 22). Next, the phase is calculated from the intensity of the plurality of lights (Step 23).

In the present embodiment as well, it is possible to fix the position of the detector 20. Additionally, in the present embodiment, it is possible to obtain the intensity of the plurality of lights with a single exposure, that is, with a single imaging. At this time, a dynamic change in phase can be captured. In other words, if it's single-exposure, the object 50 can be continuously photographed to reproduce the dynamic change in phase.

Also, in this embodiment, higher-order TIE in single exposure can be applied. In other words, three or more images with different defocus distances can be obtained at once. However, in the present embodiment, when dispersing light, the dispersion distance and the number of dispersions are limited by the size of the detector surface. Therefore, it is assumed that obtaining the intensity of light in 3 to 4 wavelengths with a single imaging is the limit.

### Embodiment 3

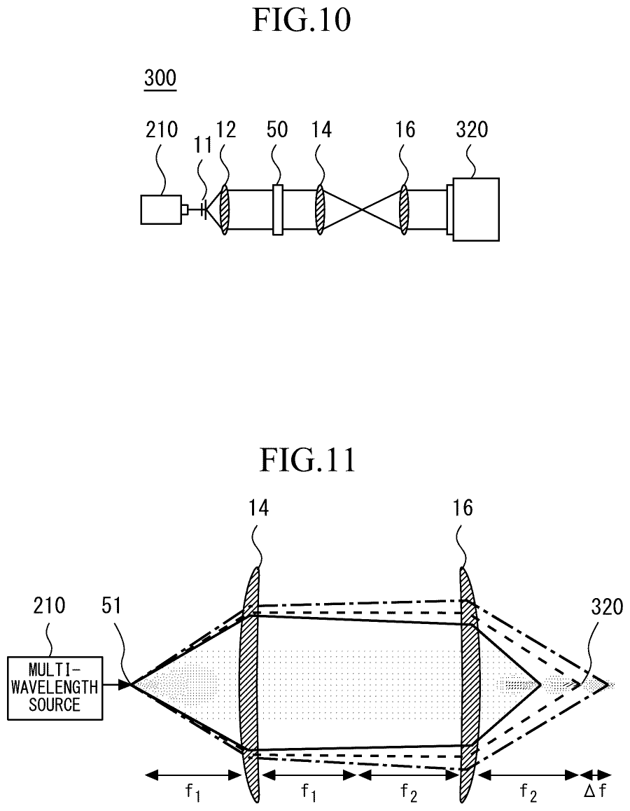

FIG. 10 is a diagram explaining the structure of a phase calculating apparatus 300 according to Embodiment 3. The light source 210 is a multi-wavelength source. The light source 210 irradiates lenses 14 and 16 with the plurality of lights having different wavelengths simultaneously. The detector 320 is a color camera. Other configurations are the same as those in Embodiment 1.

FIG. 11 is a diagram illustrating the propagation of the plurality of lights according to Embodiment 3. It should be noted that in FIG. 11, the collimator is omitted. Additionally, for convenience in FIG. 11, the manner in which the image of the object 50 is formed when it is a simple point light source is illustrated. In this embodiment, similarly to Embodiment 1, the plurality of lights with different wavelengths disperse upon passing through lenses 14 and 16, resulting in chromatic aberration.

In this embodiment, similar to Embodiment 1, the intensity of the plurality of lights with different optical paths due to chromatic aberration is measured by fixing detector 320. This enables imaging equivalent to imaging at two or more locations along the z-axis. Thus, using equations (2) and (3), the phase can be calculated.

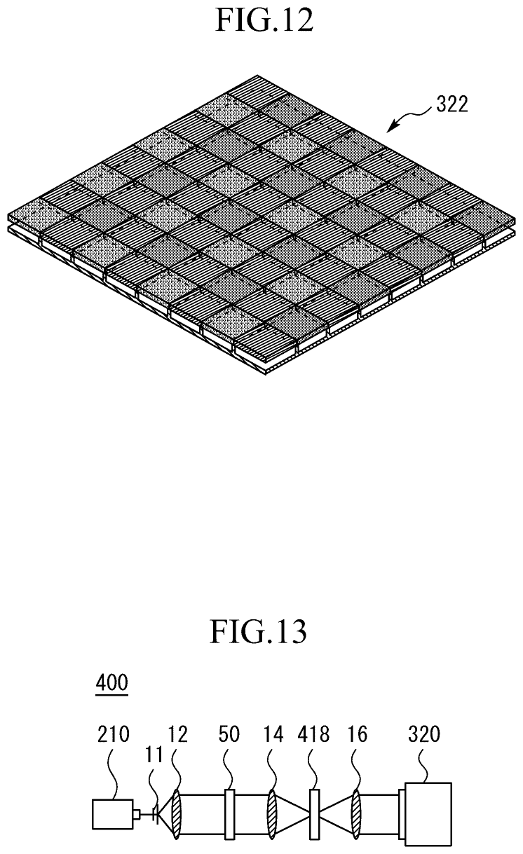

Furthermore, in the present embodiment, the detector 320, which is a color camera, can acquire the intensity of the plurality of lights having different focusing positions in one capture. FIG. 12 is a perspective view of a color filter 322 according to Embodiment 3. A color filter 322 is provided on the imaging surface of a detector 320. The color filter 322 has a Bayer array. In the color filter 322, for example, a filter of one color, red, green, or blue, is arranged in front of each sensor of a color camera. This enables the acquisition of intensity for each wavelength in a single shot. Pixels of unsupported wavelengths are subjected to interpolation processing.

The flow of the method for calculating the phase of the present embodiment is similar to the flow of Embodiment 2. First, a plurality of lights with different wavelengths are simultaneously irradiated through an object 50, which is the measurement target, and onto lenses 14 and 16 (Step 21). Next, while keeping the position of detector 320 fixed, the detector 320 measures the intensity of the plurality of lights propagating through different paths due to chromatic aberration (Step 22). Next, a phase is calculated from the intensity of the plurality of lights (Step 23).

In this embodiment as well, the detector 320 can be fixed in position. Also, in this embodiment, the intensity of the plurality of lights can be acquired in a single imaging, allowing capture of dynamic phase changes.

Furthermore, in this embodiment, higher-order TIE can also be applied in a single exposure. In the present embodiment, the number of intensity that can be obtained with a single imaging is constrained by the pixel subdivision number of the color camera. Generally, the pixel subdivision number is about 3 or 4. For this reason, it is inferred that obtaining the intensity of light for 3 or 4 wavelengths with a single imaging is the limit.

### Embodiment 4

FIG. 13 is a diagram illustrating the configuration of a phase calculation apparatus 400 according to Embodiment 4. In the phase calculation apparatus 400, a diffraction grating 418 is provided between a lens 14 and a detector 320. Specifically, the diffraction grating 418 is located between the lens 14 and the lens 16. The detector 320 acquires intensity of the plurality of lights that have passed through the diffraction grating 418. Other configurations are the same as those in Embodiment 1.

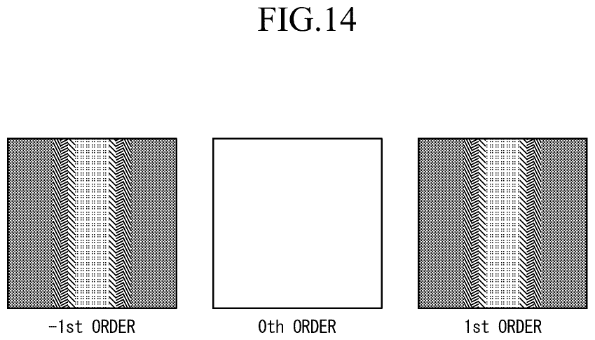

FIG. 14 is a diagram showing the 1st order diffracted light component and the −1st order diffracted light component detected by the detector 320 according to Embodiment 4. In the present embodiment, by means of the diffraction grating 418, the −1st order diffracted light component and the −1st order diffracted light component are generated on the detector surface. These correspond to intensity distributions with positive and negative defocusing distances, respectively. In other words, owing to the diffraction grating 418, two images with different defocusing distances can be acquired. Furthermore, in this embodiment as well as in Embodiment 3, the plurality of lights of different wavelengths disperse upon passing through lenses 14 and 16, causing chromatic aberration. In other words, a number of the intensity distributions obtained is equal to the number of two images by the diffraction grating 418 multiplied by the number of dispersions due to chromatic aberration in Embodiment 3. In addition, pixels of non-corresponding polarizations and non-corresponding wavelengths are interpolated.

In the embodiment mentioned above, in addition to the effects of Embodiment 3, it is possible to apply a higher-order TIE with a single exposure. In this embodiment, it is possible to obtain more than twice the number of light intensity as in Embodiment 3 with a single imaging. According to the higher-order TIE, the accuracy of TIE's difference approximation can be improved. Moreover, fitting intensity variations becomes possible. Thus, a more accurate calculation of the phase distribution becomes possible. Additionally, it is possible to improve the noise resistance in the method for calculating the phase.

It should be noted that the technical features described in each embodiment may be appropriately combined.

According to the method for calculating the phase and the phase calculating apparatus according of the present disclosure, the phase is calculated from the intensity the plurality of lights propagating along mutually different paths by transmitting through the optical component. Therefore, the position of the detector can be fixed.

Obviously many modifications and variations of the present disclosure are possible in the light of the above teachings. It is therefore to be understood that within the scope of the appended claims the disclosure may be practiced otherwise than as specifically described.

The entire disclosure of a Japanese Patent Application No. 2024-192598, filed on Nov. 1, 2024 including specification, claims, drawings and summary, on which the Convention priority of the present application is based, are incorporated herein by reference in its entirety.

1. A method for calculating a phase, the method comprising:
irradiating a plurality of lights with different wavelengths on an optical component via a measurement target,
obtaining intensity of the plurality of lights by a detector while fixing a position of the detector, the plurality of lights propagating along mutually different paths by transmitting through the optical component, and
calculating a phase from the intensity of the plurality of lights.

2. A method for calculating a phase according to claim 1, wherein
in the irradiating, irradiating the plurality of lights sequentially on a lens which is the optical component, and
in the obtaining, the intensity of the plurality of lights having different focusing positions is obtained.

3. A method for calculating a phase according to claim 1, wherein
in the irradiating, irradiating, simultaneously, the plurality of lights on a prism, which is the optical component, to disperse the plurality of lights, and
in the obtaining, obtaining the intensity of the plurality of dispersed lights by the detector.

4. A method for calculating a phase according to claim 1, wherein
in the irradiating, irradiating, simultaneously, the plurality of lights on a lens, which is the optical component,
in the obtaining, obtaining the intensity of the plurality of lights having different focusing positions by the detector, which is a color camera.

5. A method for calculating a phase according to claim 4, wherein
a diffraction grating is provided between the lens and the color camera, and
in the obtaining, obtaining the intensity of the plurality of lights that have passed through the diffraction grating by the color camera.

6. A method for calculating a phase according to claim 3, wherein in the obtaining, obtaining the intensity of the plurality of lights in a single imaging by the detector.

7. A phase calculating apparatus comprising:
an optical component configured to allow incidence of a plurality of lights with different wavelengths that have passed through a measurement target,
a detector configured to detect intensity of the plurality of lights propagating along mutually different paths by transmitting through the optical component, and
a calculation circuit configured to calculate a phase from the intensity of the plurality of lights.

8. A method for calculating a phase according to claim 4, wherein in the obtaining, obtaining the intensity of the plurality of lights in a single imaging by the detector.

9. A method for calculating a phase according to claim 5, wherein in the obtaining, obtaining the intensity of the plurality of lights in a single imaging by the detector.
